(19) United States
(12) Patent Application Publication
(10) Pub. No.: US 2004/0162874 A1
(43) Pub. Date: Aug. 19, 2004

(54) Browser testing system and method thereof

(75) Inventors: Moon-young Woo, Suwon-si (KR); Sung-nam Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/761,317

(22) Filed: Jan. 22, 2004

(30) Foreign Application Priority Data
Feb. 13, 2003 (KR) 10-2003-0009078

(51) Int. Cl. G06F 15/16; G06F 15/173

(52) U.S. Cl. 709/203; 709/224

(57) ABSTRACT

A browser testing system and method thereof are provided. The browser testing system includes a device with a browser connectable to the Internet installed thereon; and a browser test server that is connected to the device through a wire/wireless communication network. The browser test server registers test cases for use in testing the browser, creates a session from predetermined test cases selected by a tester that gains access to the browser test server through the communication network, provides the tester with the created session, and stores result values obtained from a browser test using the provided session.

### BACKGROUND OF THE INVENTION

This application claims the priority of Korean Patent Application No. 10-2003-0009078 filed on Feb. 13, 2003, in the Korean Intellectual Property Office, the disclosure of which is incorporated herein in its entirety by reference.

1. Field of Invention

The present invention relates to a browser testing system and method thereof. More particularly, the present invention relates to a browser testing system and method thereof, wherein a browser installed on a browser test device connectable to the Internet can be tested by using test cases with a variety of contents provided through a browser test server, thereby enabling an efficient browser test on the Internet.

2. Description of the Related Art

Generally, a browser means an application program for enabling hypertext documents in a web server on the Internet to be seen. Such a browser is widely employed in personal portable terminals such as personal computers, cellular phones and PDAs, and devices connectable to the Internet through wire/wireless communication networks, such as Internet phones and DTVs.

The browser provides users with information through a variety of contents prepared in a hypertext format, according to characteristics of the respective devices. A browser test for a device with a browser installed thereon is to test whether the contents provided in a specific web page are normally provided to a user through the browser.

The aforementioned contents are defined as indicating Markup Languages or script symbols, which are a series of symbols for describing how to show a specific document on a screen or for describing a logical structure of the document, and as including, for example, Hypertext Markup Language (HTML), Extensible Markup Language (XML), Extensible Hypertext Markup Language (XHTML), Handheld Devices Markup Language (HDML), Wireless Markup Language (WML), and common gateway interfaces (CGI).

In most browser tests, when a developer has developed test cases for web pages including the contents to be tested so as to check whether the contents are normally provided through a browser, a browser test for the finally developed test cases is manually performed in such a manner that the test cases are provided to a tester and the tester individually gains access to the respective test cases through the browser and records results obtained by means of the test through the browser on a test sheet.

FIG. 1 schematically shows a conventional browser testing process. As shown in FIG. 1, a developer develops test cases for a browser test and registers the developed test cases on a web server (\mathring{1}). The developer also prepares test sheets including URL addresses, result values, remarks and the like related to web pages corresponding to the respective test cases (\mathring{2}).

A tester connects with the web server in which the test cases have been registered, tests a browser by using the registered test cases (\mathring{3}), and records result values and remarks on columns of test sheets corresponding to URL addresses of web pages to which the tester gains access (\mathring{4}).

The developer can evaluate the function of the browser through the browser test results recorded on the test sheets.

The test of the browser manually performed by the tester requires accessing the respective sites one by one and checking the displayed information. Thus, it is very cumbersome and takes a lot of time to select a mouse or input key or to wait for the loading of web pages due to movement to the respective web pages.

Further, since the test sheets should be prepared according to the respective test cases, there is difficulty in efficiently using and keeping browser test records. Moreover, it is difficult to ensure reliability due to dependence on handwritten information for the tests.

In addition, if it is intended that a browser be tested through a variety of contents, applicable test cases should be separately prepared depending on the contents for use in the test. Furthermore, if different browser versions are tested, even though they are an identical type of browser, applicable test cases thereof should be separately prepared and managed. The preparation and management of the respective test cases according to the target browser and versions thereof to be tested complicates the testing process. Further, there is a high possibility that identical test cases are repeatedly prepared. Thus, such a test method is inefficient since the respective test cases cannot be efficiently used.

Therefore, there is a need for an efficient browser testing method by which a browser installed on a device connectable to the Internet can be tested by using test cases with a variety of contents according to the kind and version of the browser.

### SUMMARY OF THE INVENTION

The present invention is conceived to solve the aforementioned problems. An exemplary object of the present invention is to provide a method of conveniently testing a browser by using test cases with a variety of contents on the Internet, wherein the function of the browser installed on a device connectable to the Internet can be tested by using the test cases with a variety of contents provided through a browser test server.

Another exemplary object of the present invention is to provide test cases that can be systematically managed according to the versions of target browsers to be tested, through a browser test server.

A further exemplary object of the present invention is to provide a function of reporting browser test results so as to efficiently use the browser test results by collecting and recording result values obtained through processes of the browser test and by editing and retesting test cases according to the test results.

According to an illustrative aspect of the present invention for achieving the aforementioned exemplary objects, a browser testing system comprises a browser test server connected via wired or wireless communication networks to a device equipped with a browser operable to access the Internet, wherein the browser test server registers therewith test cases to test the browser, provides a tester with a session generated as a predetermined test case according to a selection by the tester making an access thereto through the communication networks, and stores thereon a value obtained from the browser testing by use of the session.

According to another illustrative embodiment of the present invention for achieving the aforementioned exemplary objects, a browser testing system comprises a browser testing device on which a browser connected to wired/wireless communication networks, by which it can access the Internet, is installed, wherein the browser testing system tests the browser through a browser test server where test cases to test the browser are registered, wherein the browser test server provides the tester with a session generated as a predetermined test case according to a selection by the tester accessing the browser test server through the communication networks, and wherein the browser test server obtains a value from the browser testing and reports results of the browser testing.

According to yet another illustrative embodiment of the present invention, a browser testing system comprises a browser test server to which a browser testing device is connected via one or more wired/wireless communication networks, the browser test server registers therewith test cases to test the browser, provides a tester with a session generated as a predetermined test case according to a selection by the tester accessing the browser test server through the communication networks, and stores thereon a value obtained during the browser testing process by use of the session.

An illustrative browser testing method for achieving the exemplary objects of the present invention comprises a session creating step of creating a session including predetermined test cases according to selection by a tester that gains access to a browser test server in which test cases for use in testing a browser installed on a device connectable to the Internet are registered; and a browser testing step of testing the browser by using the created session and of recording result values of the browser testing.

According to another illustrative embodiment of the present invention, there is provided a browser testing method comprising a test case developing step of receiving test cases for use in testing a browser installed on a device connectable to the Internet and registering the received test cases in a database; and a browser testing step of collecting result values obtained from a tester during a browser test using a session that is created by the tester and registered in the database and recording the collected result values in the session.

According to a further illustrative embodiment of the present invention, there is provided a browser testing method comprising a test case developing step of receiving test cases for use in testing a browser installed on a device connectable to the Internet and registering the received test cases in a database; a session creating step of creating a session with predetermined test cases selected from the database by a tester; and a browser testing step of testing the browser by using the created session, collecting result values obtained from the browser testing and recording the collected result values in the session.

Preferably, but not necessarily, each of the browser testing methods further comprises a test result reporting step of editing the test cases, which constitute the session and have the test result values, and reporting results of the browser test.

According to a still further illustrative embodiment of the present invention, there is provided a browser testing method comprising a test case developing step of receiving test cases for use in testing a browser installed on a device with an Internet connection function and registering the received test cases in a database; a session creating step of creating a session by selecting predetermined test cases from the database; and a browser testing step of testing the browser by using the created session, collecting result values obtained from the browser testing and recording the collected result values.

Preferably, but not necessarily, the browser testing method further comprises a test result reporting step of editing the test cases, which constitute the session with the test result values recorded therein, and reporting results of the browser testing.

### BRIEF DESCRIPTION OF THE DRAWINGS

The above and other objects and features of the present invention will become apparent from the following description of illustrative, non-limiting embodiments given in conjunction with the accompanying drawings, in which:

FIG. 1 is a schematic diagram illustrating a conventional browser testing process;

FIG. 2 is a schematic diagram showing a configuration of a browser test system according to an illustrative embodiment of the present invention;

FIG. 3 shows configurations of platforms for a browser test that are constructed on the browser test server;

FIG. 4 schematically illustrates a process of a browser testing method according to another illustrative embodiment of the present invention;

FIG. 5 schematically illustrates a test case developing process under a test case development environment according to a further illustrative embodiment of the present invention;

FIG. 6 schematically illustrates a session creating process in the browser-testing platform according to the further illustrative embodiment of the present invention;

FIG. 7 schematically illustrates a browser testing process in the browser-testing platform according to the further illustrative embodiment of the present invention;

FIG. 8 schematically illustrates a test result reporting process in a browser test-reporting platform according to the further illustrative embodiment of the present invention;

FIG. 9 shows displayed screens for a process of registering a target browser (subject) to be tested according to a still further illustrative embodiment of the present invention;

FIG. 10 shows a displayed screen for a version adding process according to a still further illustrative embodiment of the present invention;

FIG. 11 shows a displayed screen for a test case developing process according to a still further illustrative embodiment of the present invention;

FIG. 12 shows a displayed screen for a file creating process according to a still further illustrative embodiment of the present invention;

FIG. 13 shows an initially displayed screen for a browser testing process according to a still further illustrative embodiment of the present invention;

FIG. 14 shows a displayed screen for a session creating process according to a still further illustrative embodiment of the present invention;

FIG. 15 shows a displayed screen for a session accessing process in a web page according to a still further illustrative embodiment of the present invention;

FIG. 16 shows a displayed screen for a browser testing process using a test case according to a still further illustrative embodiment of the present invention; and

FIG. 17 shows a displayed screen for a browser test result reporting process according to a still further illustrative embodiment of the present invention.

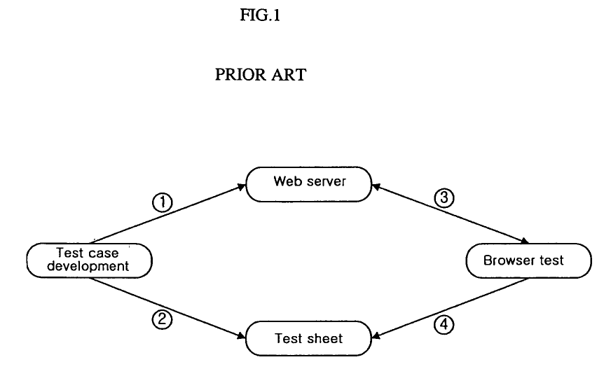

### DETAILED DESCRIPTION OF THE INVENTION

Hereinafter, exemplary configurations and operations of a browser test device, a browser test server and a system including them will be described in detail with reference to the accompanying drawings. Particularly, the configuration and operation of the present invention will be described by means of a typical browser test system.

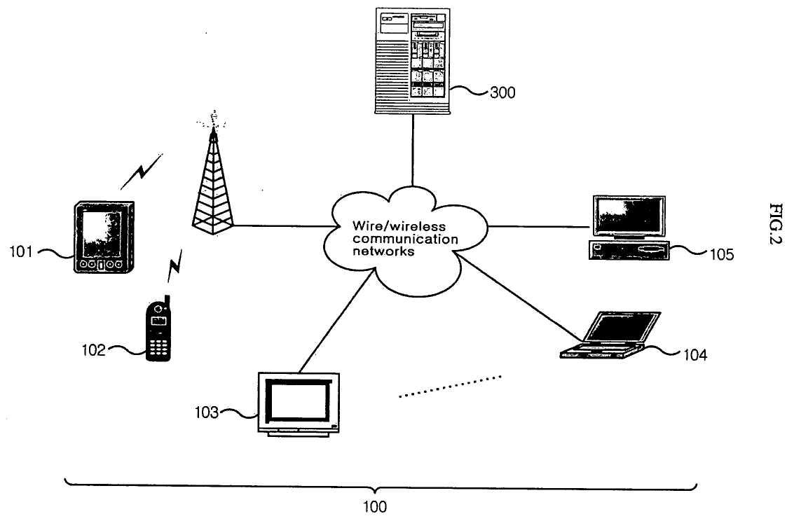

FIG. 2 is a schematic diagram showing a configuration of a browser test system according to an illustrative embodiment of the present invention.

As shown in FIG. 2, the browser test system according to the present invention generally comprises a plurality of browser test devices 100 and a browser test server 300.

Each of the browser test devices 100 is connected to wire/wireless communication networks and gains access to the browser test server 300 through connection to the Internet so as to test a browser installed in the device. The browser test devices include devices with mobile browsers installed thereon such as a PDA 101 and a mobile phone 102, and devices with web browsers for a wire Internet service installed thereon such as a digital TV 103, a notebook computer 104 and a desktop computer 105.

The browser test server 300 is connected through the wire/wireless communication networks to the devices on which the browsers connectable to the Internet are installed. The browser test server 300 registers test cases for use in testing the browsers therein, creates a predetermined test case depending on the selection by a tester that gains access thereto through the communication networks, provides the created test case to the tester, and stores result values obtained through the browser testing process using the session.

Further, the browser test server 300 includes a database consisting of categories divided by target browser according to browser characteristics. The browser test server 300 registers test cases developed by a developer or sessions created by the tester therein by category, and manages the files required for the browser test.

The sessions include browser test result values obtained through the browser testing process.

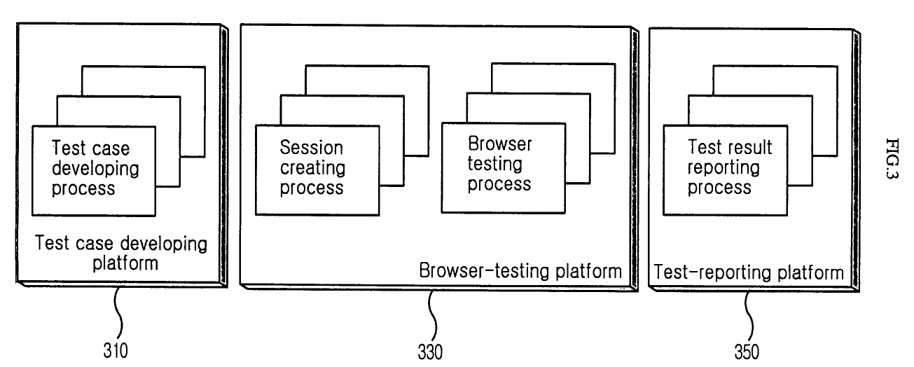

FIG. 3 shows configurations of platforms for a browser test that are constructed on the browser test server 300.

As shown in FIG. 3, the browser test server 300 generally comprises a test case developing platform 310, a browser-testing platform 330, and a test-reporting platform 350.

The test case developing platform 310 includes a test case developing process that receives contents files for use in testing a browser from the developer that gains access to the browser test server 300 through the wire/wireless communication networks, and registers the files as test cases for target browsers selected by the developer therein by category.

The browser-testing platform 330 includes a session creating process and a browser testing process.

The session creating process is performed by providing test cases with a variety of contents for a specific version of a target browser, which have been registered in a database by category, according to selection by a tester that gains access to the browser test server 300 through the wire/wireless communication networks, creating a session from the selected test cases and registering them in the selected specific version of the target browser so as to gain access to the session through a predetermined URL address.

The browser testing process is performed by providing test cases constituting a session to a tester's browser when the tester gains access to the session through a predetermined URL address via the tester's browser to be tested, receiving result values regarding whether the test cases are normally displayed from the tester, and recording the result values corresponding to the respective test cases in the session.

The test-reporting platform 350 includes a test result reporting process that is performed by providing the result values, which have been recorded in the session, in a predetermined file format to a user of the browser test server 300 and providing a session editing function by which the session is edited (e.g., selection of a test case with a specific result value, rearrangement of test cases constituting a session, and addition of a new test case) according to selection by the user to create a new session and to again inspect the browser.

For example, a process of editing a session includes a process of extracting only test cases with a necessary result value (pass, fail or skip) among test cases constituting the session with result values recorded therein, a process of again classifying test cases into predetermined groups, a process of extracting only specific test cases, or a process of adding, changing or deleting other test cases.

The developer and tester gain access to the browser test server through the wire/wireless communication networks by using the browser test device 100 that has the browser installed thereon and can be connected to the Internet. At this time, the developer and tester can gain access thereto by receiving access authority for the test case developing platform 310, the browser-testing platform 330 and the test-reporting platform 350 according to users' authority registered on the browser test server 300.

That is, users' authority includes authority as a manager with authority to generally manage the browser test server 300, a developer with authority to manage test cases in the test case developing platform 310, and a tester with authority to test the browser in the browser-testing platform 330.

Developers can be subdivided into project leaders that can set a browser test environment by registering data required for the addition of a new target browser or a new version of an already registered target browser to a category, and test case developers that can manage test cases in the test case developing platform 310.

In the browser test system of the present invention constructed as above, the test case and the session used in the present invention described above are defined as follows.

The test case refers to a contents file prepared by a developer for the purpose of testing whether predetermined contents can be normally provided through a target browser, and includes tags or script symbols of the contents to be provided through the target browser.

For example, if the developer wants to register a test case for use in checking whether images are normally displayed on a screen of a mobile browser installed on a mobile terminal, the developer selects a mobile browser as a target browser among the possible categories, prepares a contents file including tags (e.g., <img scr=″″>) enabling a specific image to be displayed on the screen, and registers the prepared contents file in the selected mobile browser.

The session refers to a web page for use in a browser test, including predetermined test cases selected by a tester in order to test a target browser. A session, including specific test cases depending on selection by the tester, is created and registered by category of a designated specific version of the target browser. Then, the tester tests the browser by gaining access to the session through the target browser, receiving the test cases constituting the session on the screen and inputting a result value indicating whether the test cases are normally provided.

The result value for each test case input by the tester is recorded in the session and then utilized as browser test data.

For example, if the tester wants to test the output of images and text in a mobile browser, the tester selects a target browser and its version according to categories corresponding to mobile browsers, and extracts contents files related to the images and text to be tested from test cases registered in the selected version of the target browser.

Then, a session including predetermined test cases is created from contents files extracted by the tester, and the tester tests the mobile browser by gaining access to the created session though the mobile browser and inputting result values for the respective test cases displayed on the screen.

For reference, in the browser test system according to the illustrative embodiment of the present invention described above, all of the respective modules may be implemented with hardware or software, or some of them may be implemented with software.

Therefore, the implementation of the browser system according to the embodiment of the present invention with hardware or software does not depart from the scope and spirit of the present invention. It will be apparent that changes and modifications to implementation thereof with software and/or hardware can be made without departing from the scope and spirit of the present invention.

Further, although the browser test device and the browser test server of the present invention have been described as a single system in connection with the browser test system, the browser test can also be performed through the browser test device or browser test server.

An exemplary method of testing a browser installed on such a device connectable to the Internet by using the browser test system constructed as above will be described in detail with reference to the accompanying drawings.

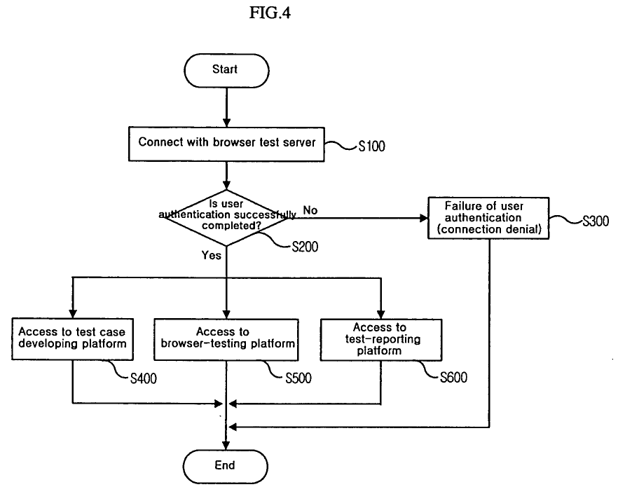

FIG. 4 schematically illustrates a process of a browser testing method according to another illustrative embodiment of the present invention.

As shown in FIG. 4, if a user externally attempts to gain access to the browser test server 300 through a wire/wireless communication network (S100), the browser test server 300 performs a user authentication process for the user and determines whether user authentication is successfully completed (S200).

If it is determined that user authentication is not successfully completed, access is denied according to failure of user authentication (S300). If it is determined that the user authentication is successfully completed, the user receives authority for the test case developing platform 310, the browser-testing platform 330 and/or the test-reporting platform 350 based on authority of the authenticated user so that the user can gain access thereto (S400, S500 and S600).

That is, the user can selectively gain access to the test case developing platform 310, the browser-testing platform 330 and/or the test-reporting platform 350 based on the user's access authority registered on the browser test server 300.

Processes of the browser testing method of the present invention performed based on the access authority provided through the user authentication process can be largely divided into a test case developing process in the test case developing platform 310, a session creating and browser testing process in the browser-testing platform 330 and a test reporting process in the test-reporting platform 350, which will be described in detail in connection with an illustrative embodiment of the present invention.

### 1. Test Case Developing Process

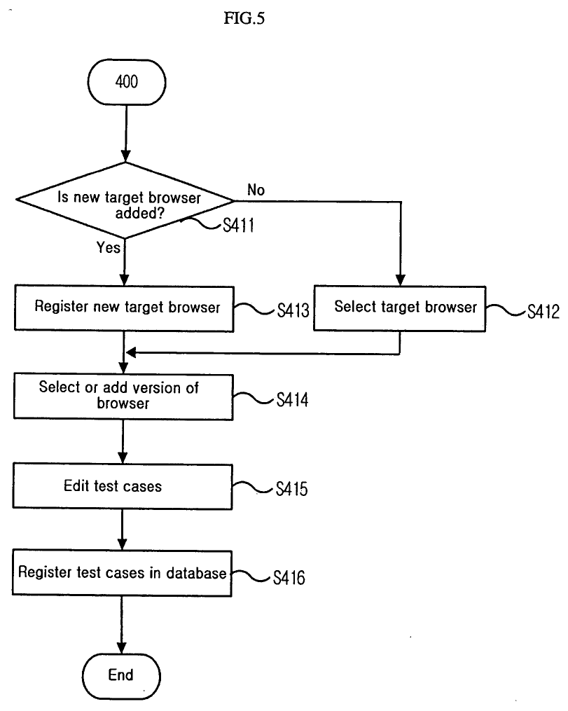

FIG. 5 schematically illustrates the test case developing process under a test case development environment according to this illustrative embodiment of the present invention.

First, a developer that has received access authority for the test case developing platform 310 through the user authentication process performed by the browser test server 300 determines whether he/she selects, according to categories, a target browser to which test cases to be developed will be applied or adds a new target browser.

The browser test server 300 determines whether the new target browser will be added based on the selection by the user (S411). If it is determined that a target browser already registered in a category has been selected, the browser test server provides information on the version of the registered browser (S412). If it is determined that an input key for adding the new target browser has been selected, information files for addition of the target browser are received from a tester and the new target browser is then registered in a relevant category (S413).

When the target browser is selected in such a manner, the version of the target browser is determined by selecting the version of the target browser to which the test cases to be registered will be applied as an existing version based on version information registered in the category of the selected target browser or by adding it as a new version thereof (S414).

Then, the developer edits contents files and prepares test cases by using tags or script symbols of contents to be tested through the target browser (S415). The prepared test cases are registered in a relevant category as test cases for the determined version of the target browser (S416).

For example, if specific tags in HTML are intended to be registered as test cases, a target browser corresponding to a web browser such as Internet Explorer or Netscape navigator and its version are selected from categories, and an HTML file that is a contents file including the specific tags to be tested is then registered in the selected version of the target browser.

### 2. Session Creating and Browser Testing Process

The session creating and browser testing process comprises a session creating process of creating a session for use in testing an existing target browser already registered in a category or a newly added browser by selecting predetermined test cases, and a browser testing process of gaining access to the created session through the target browser, testing the browser and recording result values obtained from the test.

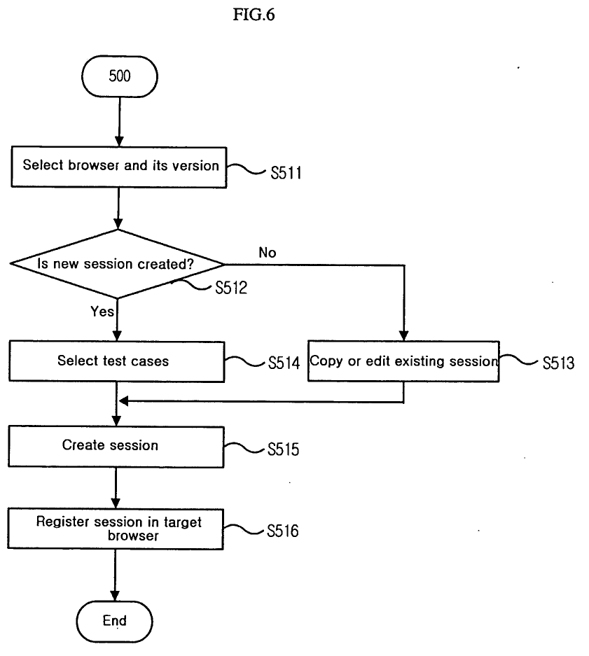

FIG. 6 schematically illustrates the session creating process in the browser-testing platform 330 according to the illustrative embodiment of the present invention.

First, a tester that has received access authority for the browser-testing platform 330 through the user authentication process performed by the browser test server 300 selects a target browser to be tested and its version from a list of browsers registered in categories (S511).

Then, it is determined whether an existing session is utilized or a new session is created as a session for use in testing the selected version of the target browser.

The browser test server 300 determines whether a new session will be created in response to key input of the tester (S512). If it is determined that an input key for utilizing an existing session has been selected, a session registered in the selected version of the target browser is provided to the tester and test cases constituting the existing session are copied or edited to reconstruct the test cases (S513).

If it is determined that an input key for creating a new session has been selected, test cases registered in the selected version of the target browser are provided to the tester and the tester then selects test cases that he/she wants to test among the provided test cases (S514).

The test cases constructed or extracted by the tester are used for creating a session with a session name designated by the tester (S515). The created session is registered in the selected version of the target browser in the category (S516).

When the session for use in testing the target browser is registered in the category of the target browser in a database in such a manner, a URL address of a web page for use in testing the target browser by means of access to the created session through the browser test server 300 is designated.

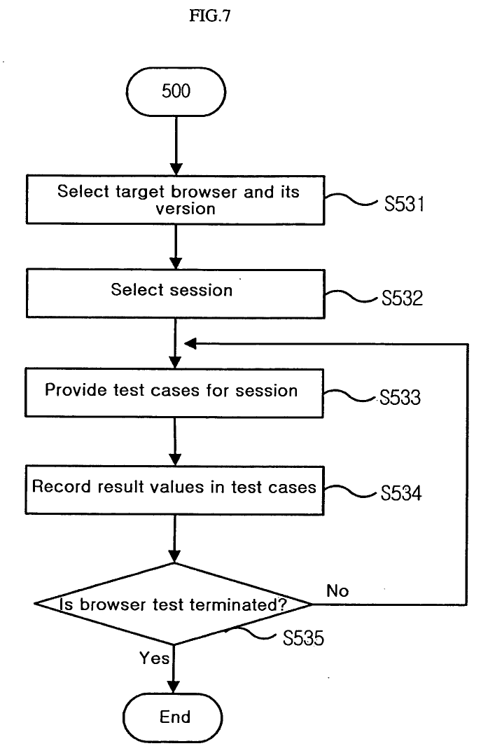

FIG. 7 schematically illustrates the browser testing process in the browser-testing platform 330 according to the illustrative embodiment of the present invention.

First, the tester gains access to a web page of a session with a URL address obtained through the session creating process by using a target browser to be tested. The browser test server 300 checks the authority of the tester through the user authentication process and provides access authority for the browser-testing platform 330 to the tester based on the check result.

The tester provided with access authority for the browser-testing platform 330 selects a target browser and its version that he/she wants to test among target browsers classified into categories (S531).

A list of applicable sessions registered in the relevant version of the target browser is provided to the tester according to the target browser and its version selected by the tester. Among the applicable sessions in the list, the tester selects a specific session to be tested through the target browser (S532).

The browser test server 300 provides test cases to the target browser according to the constitution of the session corresponding to the selection by the tester (S533). The tester checks whether the test cases are normally provided through the function of the target browser, and records check result values (S534).

The result values recorded by the tester are then recorded in the session as result values of the relevant test cases, and the browser test server 300 determines whether the browser test is terminated based on selection of an input key by the tester (S535).

If it is determined that a termination key has not been selected by the tester, the next test case is caused to be provided to the target browser according to the constitution of the session (S533). If it is determined that the termination key has been selected by the tester, the session in which the result values for the respective test cases are recorded is registered in a relevant category in the database and then terminated.

### 3. Test Reporting Process

The test reporting process comprises a test result reporting process of reporting browser test results by using a session in which the browser test results that are recorded by a target browser obtained through a target browser are recorded.

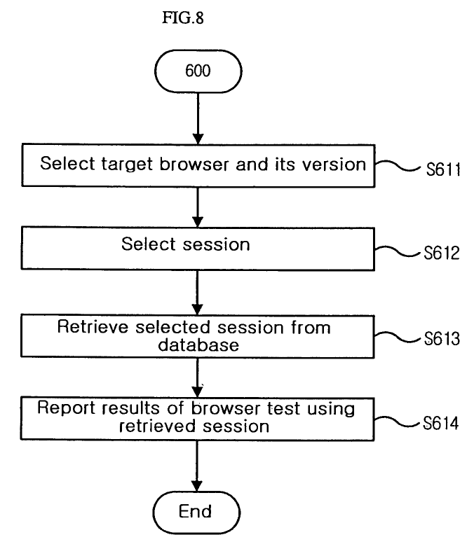

FIG. 8 schematically illustrates the test result reporting process in the browser test-reporting platform 330 according to the illustrative embodiment of the present invention.

First, a manager or developer that has received access authority for the browser-testing platform 330 through the user authentication process performed by the browser test server 300 selects a target browser and its version that he/she wants to confirm in view of test results from a list of browsers registered in categories (S611).

A list of sessions, including result values for respective test cases that have been completely tested and registered in the selected version of the target browser according to the selection of the target browser and its version by the manager or developer, is provided to the manager or developer, and the manager or developer selects a specific session to be tested from the list of sessions (S612).

The browser test server 300 retrieves the selected session from the database and provides the session to the screen (S613). The manager or developer reports test results based on information on the browser test result values recorded in the session (S614).

The reporting of test results may be made by means of a document including tables or graphs showing the result values for the respective test cases of the specific session, or by means of comparison of results values of a plurality of sessions with one another.

The browser testing method of the present invention comprising the aforementioned processes will be described in detail in connection with an illustrative embodiment of the browser testing process using the browser test system with reference to the accompanying drawings.

A developer attempts to gain access to the browser test server 300 through a wire/wireless communication network by using a predetermined device connectable to the Internet. The browser test server 300 provides the developer with access authority for the test case developing platform 310 through the user authentication process.

The developer that has gained access to the test case developing platform 310 based on the access authority provided by the browser test server 300 develops test cases for contents to be tested through a predetermined browser and selects the target browser from a list of target browsers in a relevant category in order to apply the developed test cases to the selected target browser.

If there is no registered browser corresponding to the target browser in the list of browsers in the category, a subject adding function of registering the target browser is selected.

According to the selection of the subject adding function by the developer, a user interface screen for ‘Register Subject’ function is displayed to be provided to the developer as shown in FIG. 9, and the developer inputs a subject name (i.e. target browser name) and its version that he/she wants to register.

According to the subject name and its version input by the developer, the relevant subject name and its version are added to a list of target browsers in categories and registered in the database of the browser test server 300.

Further, if the developer wants to register test cases while adding a new version of an existing target browser, he/she selects a target browser of which the new version will be added from a relevant category and selects the version adding function.

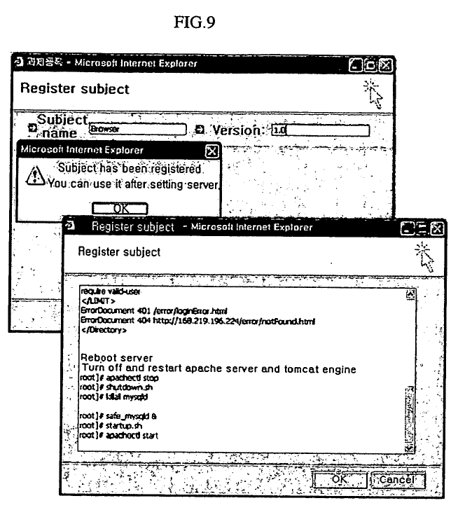

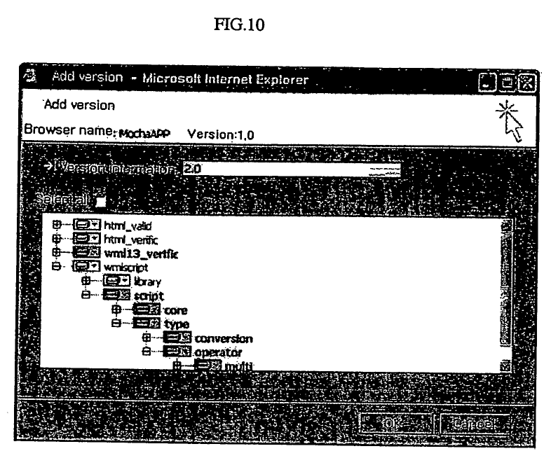

According to the selection of the version adding function by the developer, a user interface screen for ‘Add Version’ function is displayed to be provided to the developer as shown in FIG. 10. Through the user interface screen, the developer inputs new version information (2.0) to be registered in addition to an initial version of the selected target browser (MochaAPP 1.0), and selects and copies test cases registered in the initial version of the target browser, if necessary.

In such a manner, the developer determines the target browser and its version, and selects a test case menu in order to register test cases for use in testing the selected version of the target browser through predetermined contents and files for setting a test environment.

According to the selection of the test case menu by the developer, a user interface screen for developing and registering test cases to be provided is displayed to the developer as shown in FIG. 11.

The developer selects a target browser and its version in which predetermined files will be registered, through a file folder \mathring{4} that is a list of target browsers in a category displayed on the left side of the user interface screen.

The developer selects a relevant folder depending on the characteristics of files to be registered, from a list of folders registered in the target browser including a ‘Code’ folder in which test cases and files or pictures required for the test cases are registered, or a ‘Desc’ folder in which test cases are registered in the form of web page description.

After the selection of the relevant folder, the developer creates a new folder by selecting the ‘Create New Folder’ function \mathring{1} in order to register the files, and creates or uploads a file onto the browser test server 300 through the ‘Create File’ function \mathring{2} or the ‘Upload File’ function \mathring{3}.

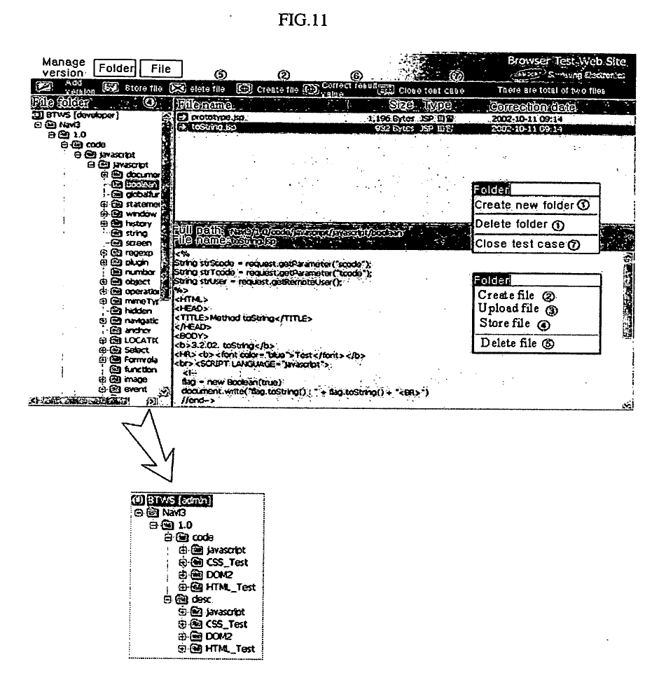

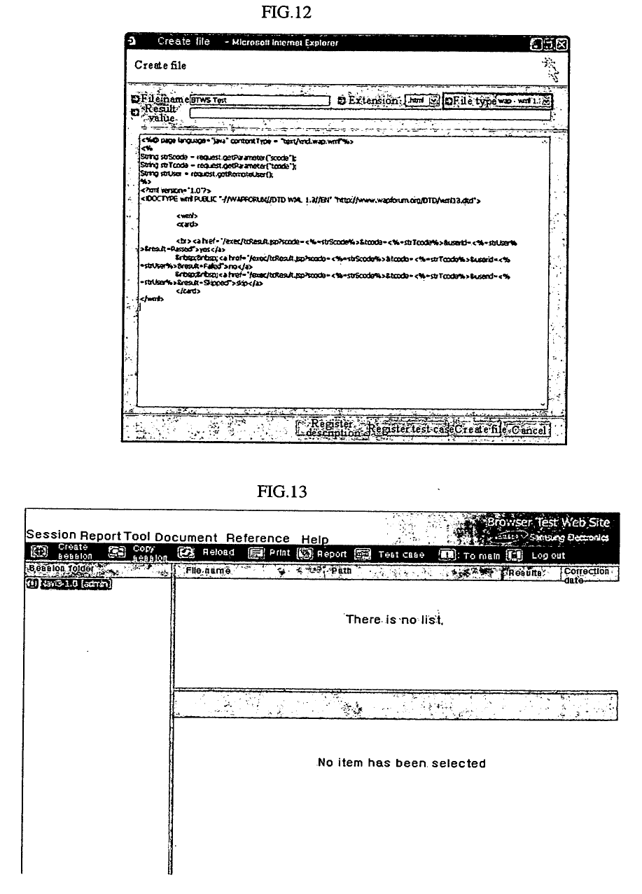

The ‘Create File’ function \mathring{2} is configured as shown in FIG. 12, and the created file is stored in the created folder according to information input by the developer. If the file is intended to be stored in the form of web page description in the ‘Desc’ folder, the ‘Register Description’ function is selected. If the file is intended to be stored as a contents file for a test case in the ‘Code’ folder, the ‘Register Test Case’ function is selected. If it is intended that the file be registered as a file for supplementing a test case in the ‘Code’ folder, the ‘Create File’ function is selected.

When the developer sets up a test environment for a predetermined browser test and develops and registers test cases in such a manner, a tester gains access to the browser test server 300 through a designated URL address by using a browser (e.g., Internet Explorer 5.0) installed on a device connectable to the Internet.

The browser test server 300 provides the tester with access authority for the browser-testing platform 330 through the user authentication process for testers that connect with the browser test server. A user interface screen for the browser test is provided to the tester, as shown in FIG. 13.

The tester confirms a session folder through the user interface screen of FIG. 13, and selects a target browser and its version to be tested from the session folder in order to create a session to be tested through the predetermined browser. Then, the tester selects the ‘Create Session’ function.

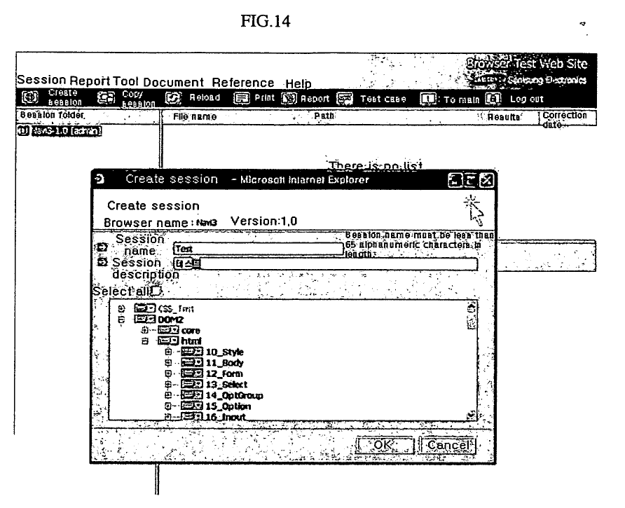

According to the selection of the ‘Create Session’ function by the tester, a pop-up window for session creation is displayed as shown in FIG. 14. The tester inputs the name and description of a session to be created though the pop-up window.

Further, the tester selects test cases for constituting the session to be created among test cases registered in the selected version of the target browser. If necessary, the tester selects the respective test cases one by one or on a folder-by-folder basis.

The session including the test cases selected by the tester is registered in a database and has a predetermined URL address so that the tester gains access to the session through the browser.

The tester that has created the session for the browser test in such a manner attempts to gain access to a web page of the session registered in the browser test server 300 through the target browser or an application program for simulation corresponding to the target browser.

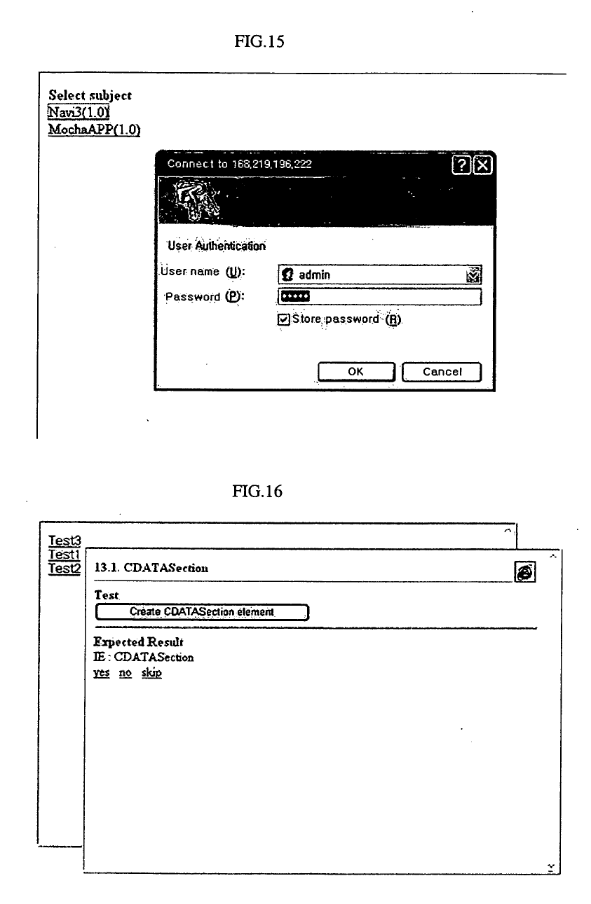

When the tester gains access to the web page of the session, a list for the browser test is displayed as shown in FIG. 15 and the tester then selects a menu corresponding to the target browser from the displayed list.

According to the selection of the menu by the tester, the browser test server 300 receives a user's name and a password to perform the user authentication process. Based on results of the user authentication, the browser test server provides the tester with test cases constituting a session of the selected browser through the user interface screen shown in FIG. 16.

The tester checks whether the contents of the test cases are normally provided through the web page including the test cases provided as shown in FIG. 16, and selects result values (e.g., yes, no or skip) for the respective test cases.

The result values input according to the selection of the result values of the tester are registered as test cases corresponding to the session.

In such a manner, the tester tests the target browser by checking whether the target browser normally provides the contents of the respective test cases by means of the test cases constituting the created session.

When the browser test is terminated, the manager or developer gains access to the test-reporting platform 350 and confirms the browser test results, according to his/her access authority that has been already set in the test-reporting platform 350.

The browser test server 300 provides a session list with predetermined result values recorded therein to the manager or developer that gains access to the test-reporting platform 350, and provides the result values for the respective test cases constituting the session according to the selection by the manager or developer.

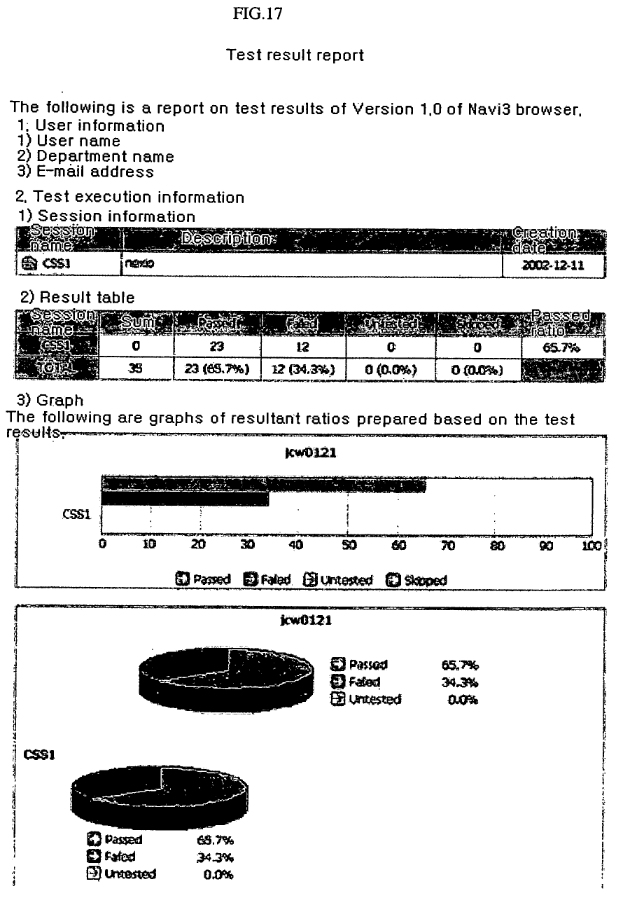

In such a manner, the manager or developer causes the browser test results obtained using the predetermined session to be printed as a document as shown in FIG. 17 and utilizes the document as data on the browser test.

Alternatively, only test cases with a specific test result value are extracted based on the browser test results so as to create a new session. Then, the browser is retested so that the browser can be efficiently tested using test cases with a variety of contents.

According to the present invention, the function of the browser installed on the device connectable to the Internet can be conveniently and efficiently tested on the Internet by using test cases with a variety of contents provided by the browser test server.

Further, there are advantages in that the test cases with a variety of contents can be systematically managed through the browser test server according to target browsers and their versions, and the browser test result values registered on the browser test server can be efficiently utilized.

The present invention has been described in connection with the illustrative embodiments thereof shown in the accompanying drawings, which are mere examples of the present invention. It can also be understood by those skilled in the art that various changes and modifications thereof can be made thereto without departing from the scope and spirit of the present invention defined by the claims. Therefore, the true scope of the present invention should be defined by the technical spirit of the appended claims.

What is claimed is:

1. A browser testing system comprises a browser test server connected via one or more wired or wireless communication networks to a device equipped with a browser operable to access the Internet,
wherein one or more test cases to test the browser are registered with the browser test server,
wherein the browser test server provides a tester with a session generated as a predetermined test case according to a selection by the tester accessing the browser test server through the communication networks, and
wherein the browser test server stores one or more values obtained from the browser testing by use of the session.

2. A browser testing system comprises a browser testing device on which a browser connected to one or more wired or wireless communication networks, by which the browser is allowed to access the Internet, is installed,
wherein the browser is tested through a browser test server where one or more test cases to test the browser are registered,
wherein the browser test server provides a tester with a session generated as a predetermined test case according to a selection by the tester accessing the browser test server through the communication networks, and
wherein the browser test server stores one or more values obtained from the browser testing by use of the session.

3. A browser testing system, comprises:
a browser testing device on which a browser operable to access the Internet is installed; and
a browser test server connected to the browser testing device via one or more wired or wireless communication networks, the browser test server registers one or more test cases to test the browser, provides a tester with a session generated as a predetermined test case according to a selection by the tester accessing the browser test server through either of the communication networks, and stores one or more values obtained during the browser testing by use of the session.

4. The browser testing system according to claim 1 or claim 3, wherein the browser test server comprises:
a first platform for developing a test case, into which a test case for testing the browser is entered and registered with a database;
a second platform for testing the browser, registering a session including a predetermined test case as selected by the tester with the database, collecting the values obtained through the browser testing by use of the session and recording the values in the session; and
a third platform for reporting a result from the browser testing through the session recorded with the values.

5. The browser testing system according to claim 4, wherein the database includes one or more test cases and one or more sessions stored by categories classified according to browser characteristics, and each of the sessions includes the values obtained from the browser testing.

6. The browser testing system according to claim 4, wherein reporting the result of the browser testing includes representing the values for the test cases as at least one of tables and graphs and outputting the represented values as a document.

7. The browser testing system according to claim 4, wherein reporting the result of the browser testing includes creating a new session by extracting, deleting or adding only those test cases having a particular value from or to the test cases and retesting the browser by using the newly created session.

8. The browser testing system according to any one of claims 1 to 3, wherein each of the test cases is a contents file including one or more tags or one or more script symbols corresponding to predetermined contents that will be tested as to whether the contents are normally provided through the browser.

9. The browser testing system according to any one of claims 1 to 3, wherein the session includes the predetermined test case selected by the tester and is a web page for the browser testing, the web page having a predetermined URL address that indicates a location where the web page is registered on the browser test server.

10. A browser testing method, comprising:
a session creating step of creating a session including one or more predetermined test cases as selected by a tester that gains access to a browser test server in which one or more test cases for use in testing a browser installed on a device connectable to the Internet are registered; and
a browser testing step of testing the browser by using the created session and of inputting result values of the browser test.

11. A browser testing method, comprising:
a test case developing step of receiving one or more test cases for use in testing a browser installed on a device connectable to the Internet and registering the received test cases in a database; and
a browser testing step of collecting result values obtained from a tester during browser testing, the browser testing using a session created by the tester and registered in the database, and recording the collected result values in the session.

12. A browser testing method, comprising:
a test case developing step of receiving one or more test cases for use in testing a browser installed on a device connectable to the Internet and registering the received test cases in a database;
a session creating step of creating a session with one or more predetermined test cases selected from the database by a tester; and
a browser testing step of testing the browser by using the created session, collecting one or more result values obtained from the browser test and recording the collected result values in the session.

13. The method as claimed in any one of claims 10 to 12, further comprising a test result reporting step of editing the test cases, which constitute the session and have the result values, and reporting the result values of the browser testing.

14. The method as claimed in claim 11 or claim 12, wherein the test case developing step comprises the steps of:
gaining access to a test case developing platform by a developer;
selecting a browser and its version to which the test cases will be applied in categories, after gaining access to the test case developing platform; and
creating one or more contents files for use in testing the browser as to whether the test cases are normally provided through the selected browser and its version, and registering the created contents files in the database by category.

15. The method as claimed in claim 10 or claim 12, wherein the session creating step comprises the steps of:
gaining access to a browser-testing platform by the tester;
selecting a browser and its version to be tested in categories, after gaining access to the browser-testing platform;
selecting one or more test cases to be tested among the test cases registered in the selected browser and its version and creating a session with the selected test cases; and
registering the created session in the category of the selected version of the browser and designating a predetermined URL address to the session.

16. The method as claimed in any one of claims 10 to 12, wherein the browser testing step comprises the steps of:
gaining access to a web page of the session with a predetermined URL address through the browser to be tested;
receiving the test cases constituting the session; and
receiving the result values from the tester and registering the received result values in the session, the result values indicating whether the contents of the provided test cases are normally provided through the browser.

17. The method as claimed in any one of claims 10 to 12, wherein each of the test cases is a contents file including one or more tags or one or more script symbols corresponding to predetermined contents that will be tested as to whether the contents are normally provided through the browser.

18. The method as claimed in any one of claims 10 to 12, wherein the session includes the predetermined test cases selected by the tester and is a web page for the browser test with a predetermined URL address that indicates a location where the web page is registered.
